(19) United States
(12) Patent Application Publication
(10) Pub. No.: US 2021/0387704 A1
(43) Pub. Date: Dec. 16, 2021

(54) Marine Navigation System

(71) Applicant: Diana Ramage, Auburn, AL (US)

(72) Inventor: Diana Ramage, Auburn, AL (US)

(21) Appl. No.: 16/997,201

(22) Filed: Aug. 19, 2020

Related U.S. Application Data
(60) Provisional application No. 63/037,694, filed on Jun. 11, 2020.

(51) Int. Cl. B63B 49/00; G01C 21/20

(52) U.S. Cl. CPC B63B 49/00; B63B 2213/02; G01C 21/203

(57) ABSTRACT

The present invention relates generally to a marine navigation system for identifying and tracking users traveling on watercraft over a body of water. The marine navigation application can be easily installed on a portable electronic device and works in conjunction with GPS and other sensors for providing various features to the user. The marine navigation system allows a user to share their current location with their family and friends while boating. The marine navigation system also provides a method for reaching a destination location, and displays a route across the body of water.

### CROSS-REFERENCE TO RELATED APPLICATION

The present application claims priority to, and the benefit of, U.S. Provisional Application No. 63/037,694, which was filed on Jun. 11, 2020 and is incorporated herein by reference in its entirety.

### BACKGROUND

The present invention relates generally to the field of navigation and, particularly, to a location and navigation system used for waterborne vehicles such as a boat, jet ski, kayak, canoe, paddleboard or the like. The navigation system enables users to easily track others over various bodies of water, such as a lake, river, pond, reservoir or the like, and allows users to share their location with friends and family while boating and navigating on the body of water. In addition, the navigation system of the present invention also enables a user to obtain directions across open bodies of water to different locations, and offers a more convenient method of obtaining a boater's location, keeping their friends and family informed while navigating on the open water. Accordingly, the present specification makes specific reference to a navigation system and related method for use primarily by recreational boaters that do not have separately installed radar or other systems onboard. However, it is to be appreciated that aspects of the present invention are also equally attributable to other applications, devices and methods of manufacture.

By way of background, ground based navigation has been widely deployed due to the development of various satellite systems including: global-navigation-satellite-systems (GNSS), Global Positioning Systems (GPS), Global Navigation Satellite Systems (GLONASS) and GALILEO. Satellite-based positioning systems, such as GPS, provide the user with the ability to accurately determine his or her location virtually almost anywhere on or above the Earth's surface. More specifically, the GPS system comprises approximately 24 Earth-orbiting satellites located in 6 orbital planes. Each of the Earth-orbiting satellites carries an atomic clock and continuously broadcasts radio signals indicating its current time and location. A receiver located on the Earth's surface can then receive these radio signals, and determine its distance from the satellites based on the timing of the arrival of the signals. By receiving signals from multiple different satellites, an Earth-based receiver can determine its precise location by triangulation.

These satellite-based navigation systems provide mobile applications which are often used by people in day to day life to navigate across ground surfaces. People travelling to new places or to routine places often use such location navigation applications to locate the destination, its route, traffic to the destination, points of interest along the way, or the estimated time to reach the destination. However, such navigation maps include routes to destinations on the ground surface of the Earth and, therefore, locating people on open bodies of water, particularly those used for recreational purposes, can be incredibly difficult.

Commercial shipping and other large craft typically use AIS transceivers that automatically broadcast information, such as the position of the ship, speed, and navigational status. These transmissions occur at regular intervals via a VHF transmitter built into the transceiver. The information originates from the ship's navigational sensors, typically its global navigation satellite system (GNSS) receiver and gyrocompass. These systems have the identity of the craft or ship entered at the time of installation so as the signal is transmitted, the identification information is also transmitted so that the location of the exact ship is known. Such devices are generally cost prohibitive or are generally not seen as necessary for the recreational boater.

Further, traditional navigation tools such as use of a compass or hand bearing compass, dividers, nautical charts, and the like are used by navigators while travelling on water bodies. Nautical charts are maps that depict water areas, rather than land areas. These essential navigational tools depict the physical features of oceans, seas, rivers, lakes and coastlines. Nautical charts also describe underwater features, list water depths, show navigational aids and provide many other details that assist in navigating an open body of water safely. Sometimes, a user can carry such charts and simply look around at the surroundings to determine a current location. More specifically, various floating objects such as beacons and buoys are anchored in a place to act as a marking point for travelers as they have indicia on the buoys which can be located on a navigational chart. For example, a user may be next to a big red buoy with the number five on it, and the user may look on the chart and see the red number five buoy to acquire his or her position. However, locating of position by the user in unfamiliar waters may be difficult, time-taking, inaccurate and frustrating. In addition, if the user does not have a navigational chart available, knowing the number or the color of the buoy marker is of little value in locating one's position.

Further, the use of such antiquated navigational charts typically require that the user also have a number of related accessories, such as a parallel ruler, divider, pencil, stopwatch, etc., to measure a direction and/or distance on the nautical chart. Unfortunately, such charts and related accessories may not always be readily available, particularly for the recreational water enthusiast. Further, such navigational charts and accessories do not permit a user to share his or her precise location with a remote user.

More specifically, while boating in lakes, rivers, oceans and the like, people may tell their friends and family where they are going while on the boat as a safety precaution or as a matter of convenience. However, the user may then easily and/or unknowingly veer off the intended route, and go missing over large bodies of water, particularly where there are few non-descript features and the shoreline doesn't have any significant topographical features or landmarks. In such scenarios, the family members and other concerned individuals have no way of obtaining the exact location of the user on the boat or other watercraft, and cannot provide help if needed. Further, while travelling out on a boat and using current GPS navigation systems, directions given on the GPS tracking software application typically try to get the user to go toward the nearest road and do not show routes across the water, and therefore, the routes shown on the current navigation systems are not at all useful while travelling on water bodies. Unfortunately, this problem is compounded when the nearest road or highway turns away from the shoreline, regularly deviates from the shoreline, or is concealed by significant obstacles, such as trees, hills and other topological features that make it difficult to track the road from the water. Moreover, plotting one's position in accordance with a road is often useless when the preferred location is along a different portion of a lake, such as a wilderness area that has no roads or other convenient markers.

Therefore, there exists a long felt need in the art for an inexpensive and convenient marine navigation system used in conjunction with a recreational watercraft. There also exists a long felt need in the art for a location detection and navigation system that graphically illustrates a route or safe passage across a body of water, and that enables a user to determine an accurate position while minimizing the amount of navigation tools needed (or to be carried) to provide the necessary navigation assistance. Moreover, there is a long felt need in the art for a navigation method that enables a user to share his or her location with friends and family members while travelling over the open water, and for a marine navigation system that does not require the need to access land based locations in order to get directions based on the nearest road and that visually displays safe passageways and routes on a map across the water. Additionally, there is a long felt need in the art for a marine navigation mobile application that enables a user to view a real-time position or location on maps, and that shows other parameters such as speed, direction and the like. Finally, there is a long felt need in the art for a marine navigation system that enables a user to locate the position of another user in unfamiliar waters in a quick, easy, accurate and hassle-free manner.

The present invention, in one exemplary embodiment, is a unique marine navigation system that is particularly useful for recreational watercraft users. The marine navigation application enables a user to view real-time positions on nautical maps on any smartphone, tablet device or the like. More specifically, the application utilizes GPS sensors which are receivers with antennas that use a satellite-based navigation system with a network of 24 satellites in orbit around the Earth to provide position, velocity, and timing information to the user. The data collected by the GPS sensors may be plotted on digital nautical charts uploaded from the software after installation of the software application on the smart device, to locate the users on water bodies. Additionally, the marine navigation application enables the user to determine speed, distance left to destination, mark favorite destinations, assess water conditions, and other useful information. Further, the navigation system of the present invention allows the users to share their current location with their family members and friends, thereby allowing them to track their position while out boating on the water.

In this manner, the improved marine navigation system of the present invention accomplishes all of the forgoing objectives, thereby providing an easy solution to determine a real-time location of a person travelling on a boat or the like over any body of water. A primary feature of the present invention enables a user to determine other parameters of the route, such as distance left to destination, traffic data, speed, direction and other useful information, and allows the user to share his or location data with their colleagues, friends and family members over a wireless network connection. Finally, the location and navigation system of the present invention is capable of providing an accurate route to a particular destination across the body of water, in an easy and hassle-free manner.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a unique marine navigation application and system for navigation over open bodies of water, and that is particularly useful for recreational watercraft enthusiasts. The marine navigation application of the present invention enables a user to view real-time positioning on nautical maps on any smartphone, tablet device or the like, and utilizes GPS sensors that interact with a satellite-based navigation system to provide position, velocity, and timing information to produce the information viewed by the user via the application. More specifically, the data collected by the GPS sensors is analyzed by the application and plotted on digital nautical charts viewable by the user on a smart phone, tablet or the like. Additionally, the marine navigation application enables the user to determine speed, distance remaining to the destination, mark favorite destinations, assess traffic on the water, and other useful information. The navigation system of the present invention also allows the users to share their current location with their family members and friends, thereby allowing them to track their position on the body of water and improving overall safety.

The subject matter disclosed and claimed herein, in one embodiment thereof, comprises a marine location detection and navigation application for portable electronic devices, such as smart phones, tablets and other smart devices. The application uses GPS sensors, a wireless connection chipset, a processor and other relevant electronic components. The navigation application works in collaboration with the GPS sensors of the portable electronic device and charts the location over nautical charts pre-loaded onto the application. The GPS sensors collect GPS signals via the antenna, and the processor processes the GPS signals to generate marine navigation data. The location information extracted from the GPS signals is then plotted on the maps, and a route across the open water is created to a pre-selected destination chosen by the user. The plotted information is displayed to the user on the display of the portable electronic device.

In another embodiment of the present invention, a marine location detection and navigation application for portable electronic devices and comprising a plurality of GPS sensors, a wireless connection chipset, a processor and other relevant electronic components is disclosed. The GPS receiver receives GPS signals from a plurality of satellites orbiting the Earth, and transmits the received signals to the processor. The processor is configured to process the data received by the GPS sensors, and forward the processed data to the marine navigation application. The marine navigation application then loads the appropriate nautical charts and other maps to the display, and further plots the information received from the processor. Further, the marine navigation application is also capable of calculating other useful parameters including, without limitation, speed, distance, direction based on data collected from accelerometers, magnetic compass and other components of the electronic device, and enables a user to view the calculated navigation parameters on a display of the electronic device.

In yet another embodiment of the present invention, a marine location detection and navigation application for portable electronic devices is disclosed. The portable electronic device includes a plurality of GPS sensors, a wireless connection chipset, a processor, an accelerometer and other relevant components. To use the application, (a) a user opens the marine navigation application by clicking on an icon corresponding to the application; (b) the marine navigation application uploads nautical maps either stored on the electronic device or from servers over a wireless network; (c) the user searches and selects a destination on the uploaded nautical map; (d) the application collects data from the plurality of GPS sensors, the processor and other components of the electronic device; (e) the application plots the collected information on the loaded nautical maps, and displays an accurate location of the user and a route to the selected destination across the body of water.

In yet another embodiment of the present invention, a marine navigation application is disclosed. The marine navigation application enables a user to share and track location information while travelling on a boat, such as a pleasure craft, a sailboat, a houseboat or the like, over bodies of water, such as ponds, lakes, rivers, bays, oceans or the like. In use, a user opens the marine navigation application on his or her smartphone or smart device which is connected to a wireless network; (b) the user then selects an option to share a current marine location (which is calculated or otherwise determined in one of the manners described above); and (c) then selects a contact for sharing of the real-time location, and finally shares the accurate position with the selected contact.

In yet another embodiment, an open water navigation application is disclosed that can be installed on an electronic device such as a smartphone, tablet, laptop or can be used and downloaded from the web. The application of the present invention is specifically designed for use on the water, and uniquely providing bearing, range and closest point of approach (CPA) calculations. Further, the application allows the users to share his or her current location by tapping an icon on the application that has been previously shared with the other users. Further, the application provides a real time map view of the individual's boat and other boats within a specified range such as within 30 NM (nautical miles) over normal or satellite map views. The application further allows a user to enter boat details including length, width, type, MMSI (maritime mobile service identity—typically a 9-digit unique number), photos, etc. The application also offers a compass mode to sight ships on the map with heading/course or north up type settings. The application may also have additional features including, without limitation, anchor watch, theft alarms and magnetic or true north settings.

In a still further embodiment of the presently described invention, a personal navigation location system for use with recreational watercraft is described. The system is comprised of a boat or other watercraft and a smart device, wherein the smart device is comprised of cellular and/or Wi-Fi connectivity capability, a memory, and GPS interoperability. A series of navigational charts on the smart device relate to recreational waterways, and the navigational charts are used for determining a position of the boat. A selection menu allows a user to select from a plurality of navigational options and a display for displaying at least one of the series of navigational charts and information from the plurality of options.

In a yet still further embodiment of the presently described invention, a method of using a recreational boating navigational system is described and includes the initial steps of providing a recreational watercraft and then selecting a desired waterway or open body of water. Next, a smart device is initiated and a navigational chart is chosen based on the selected waterway/body of water. Then, a request for GPS information is transmitted to a plurality of GPS satellites, and a response is received to the transmitted request. The response provides information relating to a position of the watercraft on the waterway/open body of water. The response information is then visually displayed on a navigational chart or map to obtain a user's position, and the position is then transmitted to a member of a contact list in a memory on the user's smart device.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one possible embodiment of the marine navigation application of the present invention installed on a smart phone in accordance with the disclosed structure;

FIG. 2 illustrates a perspective view of a user selecting a destination on a map of the marine navigation application of the present invention in accordance with the disclosed structure;

FIG. 3 illustrates a perspective view of the map showing a potential route across an open body of water and to the selected destination on one possible embodiment of the marine navigation application of the present invention in accordance with the disclosed structure;

FIG. 4 illustrates a schematic view of one possible embodiment of a circuit utilized for the marine navigation application of the present invention in accordance with the disclosed structure;

FIG. 5a illustrates a perspective view of a user using one possible embodiment of the marine navigation application of the present invention on a portable electronic device in accordance with the disclosed structure to receive a location from a remote user; and

FIG. 5b illustrates a perspective view of a user using one possible embodiment of the marine navigation application of the present invention on a portable electronic device in accordance with the disclosed structure to navigate the watercraft to a desired destination.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a novel marine navigation application and system for navigating open bodies of water. The marine navigation application enables a user to view real-time positioning on nautical maps on any smartphone, tablet device or the like. More specifically, the application utilizes a plurality of GPS sensors, which are receivers with antennas that use a satellite-based navigation system with a network of 24 satellites in orbit around the Earth to provide position, velocity, and timing information. The data collected by the GPS sensors is then plotted on digital nautical charts uploaded into the software to locate the user or other users on a body of water. Additionally, the marine navigation application enables the user to determine speed, distance and/or time remaining to the destination, mark or identify favorite destinations, assess traffic on the water, and access other useful information. Also, the navigation system of the present invention allows the users to share their current location with their family members and friends, thereby allowing them to track their position on the body of water, which increases maritime safety.

The application is also capable of communicating with various tracking systems such as the Automatic Identification System (AIS), the coastal authorities, the Coast Guard and the like for increased safety. The marine navigation application may be connected to a wireless network in order to enable a user to more easily share his or her current location with any of the contacts stored on the portable electronic device on which the application is being utilized. Therefore, the present invention provides a way for family members and friends to easily locate and track a friend or loved one on an open body of water.

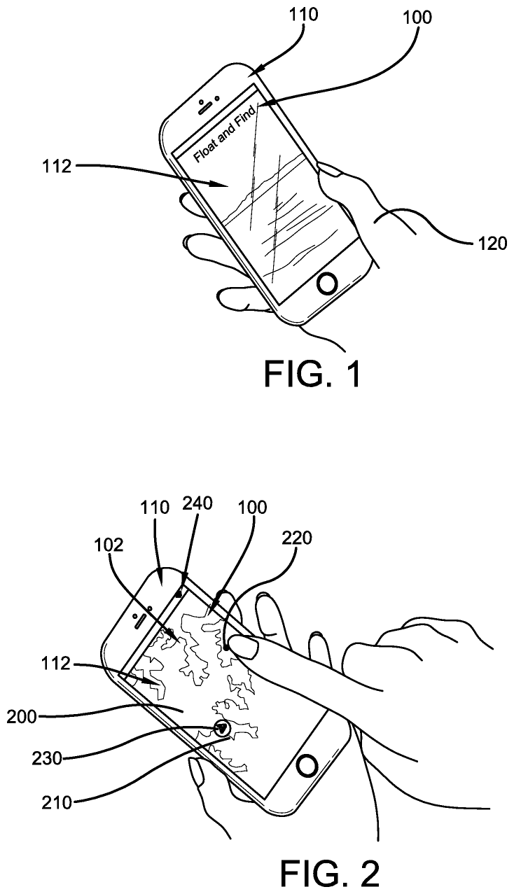

Referring initially to the drawings, FIG. 1 illustrates a perspective view of one possible embodiment of the marine navigation application of the present invention in accordance with the disclosed structure. The marine navigation or “Float and Find” application 100 is a software/mobile application for providing location and navigation data while travelling via a watercraft over any body of water, such as ponds, lakes, rivers, bays, oceans or the like. The float and find software application 100 can be easily installed on any portable electronic device 110, such as a smartphone, tablet device, laptop, or the like by downloading the application onto the device 110.

The portable user device 110 is further comprised of an operating system, such as Android, iOS, or any other compatible operating system known in the state of the art. As described more fully below, the device 110 comprises a plurality of GPS sensors, an antenna, an accelerometer, one or more magnetic sensors, a processor, a memory, an input interface, a display interface, a wireless connectivity chipset and other components commonly known in the art to be part of a smart device, which are used by the marine navigation application 100 to provide the desired features to the user. The marine navigation application 100 is an improved navigation application for use by recreational watercraft users, and which allows the users to view marine routes across water bodies to different destinations, and that provides speed, direction and other relevant information for the user.

The marine navigation application 100 includes access to various nautical charts and marine maps stored in the memory of the handheld device 110, when the application 100 is properly stored on the device 110. Alternatively, the required nautical maps or charts can be downloaded and updated from servers while the device 110 is connected to a wireless connection network such as Wi-Fi, or the like. The stored or real-time downloaded nautical charts are received by the navigation application 100 when the application is initiated by the user. Once the navigation application 100 collects the map data either from device 110 memory or from the above referenced servers, the marine navigation application 100 presents the map data to the display 112 of the electronic device 110 held by user 120. The nautical charts downloaded are preferably authentic and approved charts from sources such as NOAA data for USA, UKHO data for UK/Ireland, CHS data for Canada, and other maritime sources.

FIG. 2 illustrates a perspective view of a user selecting a destination on a map of the marine navigation application 100 of the present invention in accordance with the disclosed structure. More specifically, FIG. 2 shows a user interface 102 of the marine navigation application 100 displayed on a display interface 112 of the handheld electronic device 110. The device 110 may include any type of display unit such as LED, OLED, or the like, and can be of any size as per the requirements of the user. Once the marine navigation application 100 is opened by the user by clicking the application icon of the application 100, the application 100 shows the pre-stored nautical map 200 or downloads the required map 200 from servers over a wireless network connection such as Wi-Fi. The Wi-Fi connection icon 240 is displayed on the user interface 102 to show that the user device 110 is connected to a wireless connection, and further shows the strength of the wireless network as well. The user interface 102 displays the uploaded nautical map or chart 200 and overlays a current location 210 of the user travelling on a watercraft over a water body. The boat is displayed as a boat icon 230 on the user interface to convey the mode of travelling. In the event that the Wi-Fi signal is lost, the nautical map 200 will continue to be displayed, showing the end destination, the approximate rate of travel, and the position of the watercraft based on the last GPS information received. In this way, the individual can continue his or her journey along the previously selected path. Once the Wi-Fi signal is restored, the navigation application 100 will update the available information, and make any necessary corrections to the display on the nautical map 200.

As referenced above, the handheld electronic device 110 comprises a GPS (Global Positioning System) receiver (not shown), which is embedded in the device 110 and collects GPS signals from satellites orbiting the Earth to provide current location information 210 to the marine navigation application 100. By way of background, the Global Positioning System is a satellite-based navigation system made up of a network of satellites orbiting the Earth and transmitting signals. The GPS receiver locks onto the signal of at least three GPS satellites to calculate the GPS receiver's latitude, longitude, and altitude. The GPS receiver then provides the calculated latitude, longitude, and altitude data, as well as date, time and status data to a processor of the electronic device 110. In one embodiment of the present invention, the GPS receiver may be any commercially available GPS receiver.

Once the GPS receiver collects the location information, such as latitude, longitude and altitude data, it is sent to the processor of the electronic device 110, and the processor processes the collected location data. The marine navigation application 100 then overlays the processed latitude, longitude and altitude information to display a current user's location 210 on the nautical map 200. As best shown on FIG. 2, the user may also select a particular destination location 220 on the map 200 by searching on a destination search bar of the marine navigation application 100. Alternatively, the user may tap on any location of the nautical map 200 to select the desired destination 220.

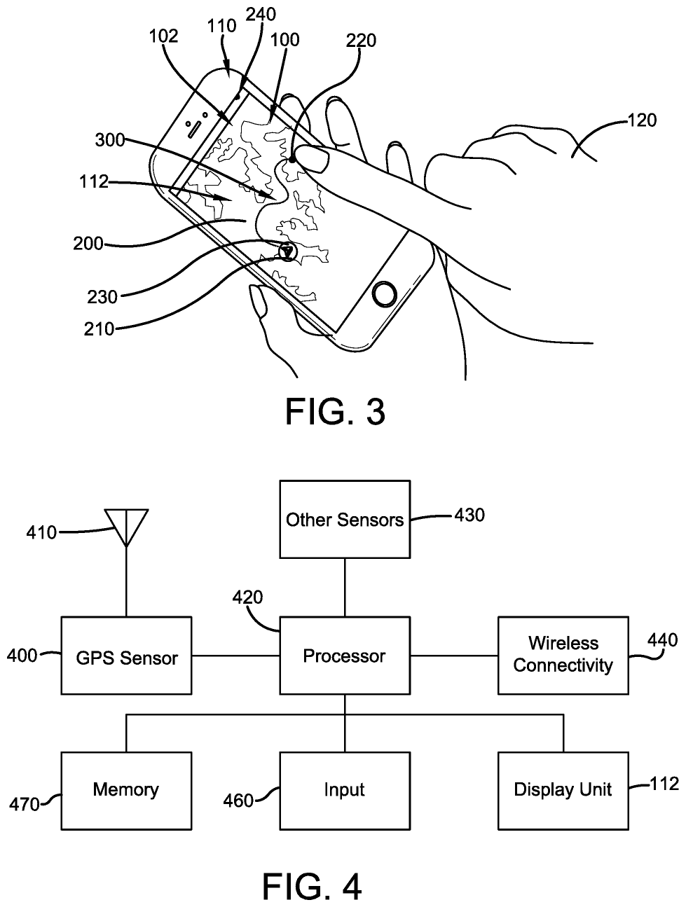

FIG. 3 illustrates a perspective view of one possible embodiment of the nautical or geographical map 200 showing route across the open water to the selected destination 220 on the marine navigation application 100 of the present invention and in accordance with the disclosed structure. More specifically, the user interface 102 of the marine navigation application 100 utilizes the user's current location 210 (determined from the interaction of the GPS sensors with the GPS satellites orbiting the Earth) and the destination location 220 selected by the user to calculate a preferred route 300 to the selected destination 220 across the waterway or other body of water.

More specifically, the route 300 may be calculated between the current location 210 and the destination location 220 based on various user selected parameters, such as shortest distance, historical route patterns, and others. Further, weather condition information may also be collected from the servers by the navigation application 100 and be factored into consideration when recommending the most appropriate route 300, or adjusting the same from time to time during transit to adjust for newly received or additional information. More specifically, based on user specified and other parameters, an optimized route 300 is initially calculated and is overlaid onto the map 200 on the display interface 112 of the handheld electronic device 110. However, adverse weather conditions, such as storms, excessive rainfall, or other similar harsh weather conditions, such as wind, hail and the like, might make it difficult for a user to travel over the body of water using the initially calculated route 300. Therefore, the marine navigation application 100 of the present invention considers the weather parameter on an ongoing basis to enable the user to travel safely over the body of water. The overlay of the route 300 may be any solid or semi-transparent, color-coded lines on a map, and based on pre-determined settings by the user.

FIG. 4 illustrates a schematic view of one possible embodiment of a circuit utilized for the marine navigation application 100 of the present invention in accordance with the disclosed structure. More specifically, FIG. 4 shows the various components of the handheld electronic device 110 which may be used in conjunction with the marine navigation application 100. In a preferred embodiment, the electronic device 110 includes a GPS receiver 400 and an antenna 410 for receiving GPS signals from the various SPS satellites orbiting the Earth. The GPS signals include information such as latitude, longitude, altitude and other relevant information. The device 110 further includes a processor 420, which receives and processes the GPS signal information so that it can be used to calculate a location. The processor 420 may include one or more of a system processor, a digital signal processor, a processing module, a dedicated hardware, an application specific integrated circuit, or other circuitry capable of executing software instructions and processing data.

The processed location information is then forwarded to the marine navigation application 100 for overlaying the location of the user on the map 200. The device 110 further comprises a wireless connection chipset 440, such as Wi-Fi chip or any other wireless connection chipset, that enables the device 110 to connect to remote servers while travelling on the body of water, and when no cellular network coverage is available. The wireless connection chipset 440 further enables the marine navigation application 100 to download the nautical maps 200 from the servers for overlaying location information on the downloaded maps 200. In another embodiment, the user may share the processed location information with their family and friends over the wireless network connection provided by the wireless connection chipset 440.

The portable electronic device 110 further includes a memory 460, which may be used to store the various nautical maps 200 which are utilized by the marine navigation application 100. The memory 460 may also store software instructions of the marine navigation application 100, and any information saved on the marine navigation application 100. The device 110 also comprises an input interface 450, such as a keypad, for inputting various data such as destination data on the marine navigation application 100, and a display unit/interface 112 that displays the user interface 102 of the marine navigation application 100. The device 110 may further include other sensors 430, such as a magnetometer, an accelerometer, inertial sensors, a gyroscope, a temperature sensor and others to provide various other information, data and details to calculate direction, speed and other parameters for the marine navigation application 100.

In an embodiment of the present invention, the marine navigation application 100 works in conjunction with the user's contact book stored of the electronic device 110 to enable the user to track and share his or her location. More specifically, the user connects the marine navigation application 100 to a wireless network connection 440 and selects an option available on the user interface 102 to share a current location 210 of the user with a person from the contact list. The user then selects a contact from the contact book to share the real-time location 210 with, and the accurate and current location 210 is then shared with the selected contact over a wireless network connection 440. If a user has a Maritime Mobile Service Identity (MMSI) number set, then the user's watercraft may also be visible on global internet Automatic Identification Systems (AIS systems) like Marine Traffic, ShipFinder and AIS Hub. An indicator light may also be included on the application display to show the status of the location transmission. The marine navigation application 100 also allows the user's position to be shared when the application is closed or running in the background.

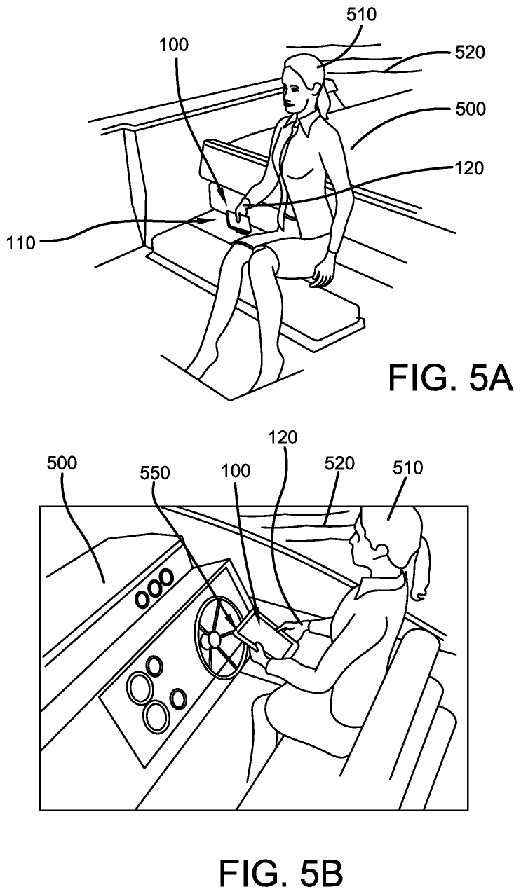

FIG. 5 illustrates a perspective view of marine navigation application 100 of the present invention used on a portable electronic device in accordance with the disclosed structure. More specifically, FIG. 5a illustrates a perspective view of a user 510 using one possible embodiment of the marine navigation application 100 of the present invention on a portable electronic device 110 in accordance with the disclosed structure to, for example, receive a location from a remote user, while travelling on a boat or other watercraft 500 over a body of water 520. Similarly, FIG. 5b illustrates a perspective view of the user 510 using the marine navigation application 100 of the present invention on a portable electronic device 110 to navigate the watercraft 500 to a desired destination on the body of water 520.

In an embodiment of the present invention, the marine navigation application 100 may be utilized by any user such as travelers, mariners, oceanographers or the like. The use of marine navigation application 100 is not limited, and can also be used for underwater surveying, buoy placement, and navigational hazard location and mapping, so long as the user device 110 is waterproof or has been provided with a waterproof housing. In a further embodiment of the present invention, the marine navigation application and system 100 may have a group feature that allows a group of users such as family members, friends to send and receive messages either privately or to everyone in the group using the group name. In yet a further embodiment of the present invention, the marine navigation application and system 100 may enable features such as speed measurement, distance measurement, direction indication, location sharing and tracking, travel time, weather forecast, bearing, and others for providing convenience to the user 510.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “marine navigation application”, “marine navigation system”, “location tracking system” and “float and find” are interchangeable and refer to the marine navigation system 100 of the present invention.

Notwithstanding the forgoing, the marine navigation system 100 of the present invention and its various structural components can be any suitable size, shape, and configuration as is known in the art without affecting the overall concept of the invention, provided that it accomplishes the above stated objectives. One of ordinary skill in the art will appreciate that the interface and features of the marine navigation application 100 and its various components, as shown in the FIGS. are for illustrative purposes only, and that many other shapes and sizes of the marine navigation application 100 are well within the scope of the present disclosure. The marine navigation application 100 and its components may have any features that ensures optimal performance during use and/or that suits need and/or preference of the navigators and travelers.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A navigation location system for use with a recreational watercraft and comprising:
a smart device, wherein the smart device is comprised of cellular and Wi-Fi connectivity capability, a memory, and a GPS interoperability;
a series of navigational charts on the smart device relating to recreational waterways, the series of navigational charts used for determining a position of the recreational watercraft on a body of water;
a selection menu, the selection menu allowing a user to select from a plurality of navigational options; and
a display for displaying at least one of the series of navigational charts and a selected navigational option.

2. The navigation location system of claim 1, wherein the plurality of navigational options includes at least one of a speed, a distance remaining to a destination, a favorite destination, and a traffic on the water status.

3. The navigation location system of claim 1, wherein the display provides the position of the recreational watercraft on the body of water.

4. The navigation location system of claim 3, wherein the smart device further comprises a contact list, and further wherein the navigation location system transmits the position of the recreational watercraft on the body of water to at least one contact on the contact list.

5. The navigation location system of claim 1, wherein the smart device includes at least one of a processor, a digital signal processor, a processing module, a dedicated hardware, and an application specific integrated circuit.

6. The navigation location system of claim 1, wherein the recreational watercraft is one of a boat, a pleasure craft, a motorboat, a sailboat, a houseboat, a canoe, a kayak and a paddleboard.

7. The navigation location system of claim 1, wherein the series of navigational charts are retrieved from a remote server.

8. The navigation location system of claim 1, wherein the series of navigational charts are retrieved from the memory of the smart device.

9. The navigation location system of claim 1, wherein the series of navigational charts are accessed via a world wide web and downloaded to the memory of the smart device.

10. The navigation location system of claim 1, wherein the selection menu provides at least one of a bearing, a range and a closest point of approach calculation for the display.

11. A smart phone navigation system for use with a recreational watercraft and comprising;
a smart phone having a memory and a Wi-Fi, a cellular and a GPS connectivity;
a series of navigational charts depicting a plurality of recreational waterways in a geographic area;
a display for displaying at least one of the series of navigational charts on the smart phone;
a processor for calculating a position of the recreational watercraft on a select one of the plurality of recreational waterways, the processor further providing a nautical bearing, a range and a closest point of approach calculations for the display; and
a contact list provided on the smart phone, wherein at least one entry in the contact list receives the position of the recreational watercraft.

12. The smart phone navigation system of claim 11, wherein the processor calculates a speed, a distance remaining to a destination, and an amount of traffic on the water for illustration on the display.

13. The smart phone navigation system of claim 12, wherein the display illustrates the position of the recreational watercraft on a select one of the plurality of recreational waterways.

14. The smart phone navigation system of claim 11, wherein the series of navigational charts are stored in the memory.

15. The smart phone navigation system of claim 11, wherein the smart phone further includes a digital signal processor, a processing module, and an application specific integrated circuit.

16. The smart phone navigation system of claim 11, wherein the series of navigational charts are accessed from a world wide web via the Wi-Fi connection or the cellular connection.

17. A method of using a recreational watercraft navigational system comprising the steps of;
providing a recreational watercraft;
selecting a waterway;
initiating a smart device;
choosing a navigational chart based on the selected waterway;
transmitting a request for GPS information;
receiving a response to the transmitted request, the response providing an information relating to a position of the recreational watercraft on the selected waterway;
displaying the position on the navigational chart; and
transmitting the position to a remote third party.

18. The method of using a recreational watercraft navigational system of claim 17, including a further step of updating the position for the remote third party after the step of transmitting the position.

19. The method of using a recreational watercraft navigational system of claim 17, wherein the response comprises a speed of the recreational watercraft.

20. The method of using a recreational watercraft navigational system of claim 17, wherein the smart device comprises a memory, a processor and a plurality of navigational charts.
